(19) United States
(12) Patent Application Publication
(10) Pub. No.: US 2024/0413455 A1
(43) Pub. Date: Dec. 12, 2024

(54) Systems and Methods for Lithium-Ion Battery Durability

(71) Applicant: The Noco Company, Glenwillow, OH (US)

(72) Inventors: James P. McBride, Phoenix, AZ (US); Christopher Stephen Walk, Gilbert, AZ (US); Matthew Michael Bosway, Queen Creek, AZ (US); Timothy Joseph Barrett, Gilbert, AZ (US); John Charles Reardon, Scottsdale, AZ (US)

(21) Appl. No.: 18/330,523

(22) Filed: Jun. 7, 2023

(51) Int. Cl. H01M 50/242; H01M 10/0525; H01M 10/42; H01M 10/653; H01M 10/657; H01M 50/211; H01M 50/271; H01M 50/291

(52) U.S. Cl. CPC H01M 50/242; H01M 10/0525; H01M 10/4257; H01M 10/653; H01M 10/657; H01M 50/211; H01M 50/271; H01M 50/291; H01M 2010/4271

(57) ABSTRACT

A battery configured to have improved thermal management and structural stability. The battery including a battery pack construction with at least one battery cell spacer having a first surface contacting substantially all of the bottom surface of a first battery cell and a second surface contacting substantially all of the top surface of a second battery cell, the battery cell spacer including an adhesive component. Additionally, the battery may include a battery management system (BMS) in electrical communication with the first and second battery cells, the BMS having one or more thermal components configured to disperse heat from the BMS, and a thermal epoxy contacting the one or more thermal components and a battery housing. The battery further including a stability cage at least partially enclosing the battery pack construction and positioned between the battery cells and the battery housing.

### CROSS-REFERENCE TO RELATED APPLICATIONS

Not applicable.

### FIELD

The present disclosure relates to batteries. Specifically, the present disclosure relates to lithium-ion batteries having features to promote durability.

### BACKGROUND

Lithium-ion batteries are the predominant type of rechargeable batteries used in many commercial applications today. Given their wide usage, lithium-ion batteries are often required to have different sizes, shapes, arrangements, and chemistries depending on the intended application. Unfortunately, lithium-ion batteries can be safety hazards when they are not properly designed, are improperly charged, or undergo severe mechanical forces (e.g. vibrations).

One way for a lithium-ion battery to become compromised is through thermal abuse due to insufficient cooling. When lithium-ion cells become overheated, they can suffer thermal runaway that can lead to cell rupture. Because many lithium-ion batteries include flammable electrolytes, a compromised lithium-ion cell can produce an explosion or fire. In order to address this issue, some lithium-ion battery designs include heat sinks associated with a battery management system (BMS), which typically includes a printed circuit board (PCB) and electronic circuitry. The heat generated by the circuitry is transferred to the heatsink, which then relies on convection through air contained within the battery housing to further dissipate the heat.

Another common way for a lithium-ion battery to become compromised is through mechanical stresses resulting from movement of the battery (e.g. a vehicle containing the battery hitting a bump in the road, a boat containing the battery going over a wave, etc.). In order to physically protect batteries, larger lithium-ion batteries are typically stored within a polymer shell, sometimes referred to as a battery housing, which can help alleviate some of the mechanical forces that the lithium-ion cells ultimately experience during usage.

### SUMMARY

The present disclosure is directed to systems and methods for improving the thermal and mechanical stability of batteries, such as lithium-ion batteries. In one aspect, battery management systems having improved thermal cooling through conduction are provided. By utilizing conductive heat transfer away from a battery management system, such as by transferring energy through a thermal resin in contact with a battery housing, cooling improvements can be realized over existing convection-based designs. Furthermore, structural improvements through the use of specialized battery spacers, specific battery cell adhesive restraints, and a battery stability cage can help ensure that battery cells do not become compromised due to forces imposed on a battery during use.

In one aspect, the present disclosure provides a battery configured to have improved stability. The battery may include a battery pack construction including a first battery cell having a top surface and a bottom surface, a second battery cell having a top surface and a bottom surface, and a battery cell spacer having a first surface contacting substantially all of the bottom surface of the first battery cell and a second surface contacting substantially all of the top surface of the second battery cell, wherein the first and the second surfaces each include an adhesive component. The battery may further include a battery management system (BMS) in electrical communication with the first and second battery cells, the BMS having one or more thermal components configured to disperse heat from the BMS, a battery housing enclosing the battery pack construction and the BMS, and a thermal epoxy contacting the one or more thermal components and the battery housing. The battery may also include a stability cage at least partially enclosing the battery pack construction and positioned between the battery cells and the battery housing. The stability cage may include a polymer frame having four sidewalls positioned in a rectangular form, wherein each sidewall includes a plurality of apertures forming a mesh pattern.

In another aspect, the present disclosure provides a battery configured to have improved stability, the battery may include a battery management system (BMS) in electrical communication with a plurality of battery cells, the BMS having one or more thermal components configured to disperse heat from the BMS, a battery housing enclosing the battery cells and the BMS, and a thermal epoxy contacting the one or more thermal components and the battery housing.

In one aspect, the present disclosure provides a method of manufacturing a battery configured to have improved stability. The method may include: providing a battery management system (BMS) in electrical communication with a plurality of battery cells, the BMS having one or more thermal components configured to disperse heat from the BMS, arranging a battery housing to enclose the battery cells and the BMS, and applying a thermal epoxy between the BMS and the battery housing, wherein the thermal epoxy contacts the one or more thermal components and the battery housing.

In another aspect, the present disclosure provides a battery configured to have improved stability, the battery may include a first battery cell having a top surface and a bottom surface, a second battery cell having a top surface and a bottom surface, a battery cell spacer having a first surface contacting substantially all of the bottom surface of the first battery cell and a second surface contacting substantially all of the top surface of the second battery cell, wherein the first and the second surfaces of the battery cell spacer each include an adhesive component.

In one aspect, the present disclosure provides a method of manufacturing a battery configured to have improved stability. The method may include: arranging a plurality of battery cell spacers between a plurality of battery cells to form a battery pack, wrapping the battery pack in a first layer of adhesive tape, wherein the first layer of adhesive tape contacts substantially all of a top surface of the battery pack, arranging a plurality of protective plates along the multiple geometric sides of the battery pack, wherein the protective plates are configured to substantially cover the multiple geometric sides, and wrapping the battery pack, the first layer of adhesive tape, and the protective plates in a second layer of adhesive tape.

In yet another aspect, the present disclosure provides a battery configured to have improved stability, the battery may include a plurality of battery cells, a battery housing configured to enclose the battery cells, the battery housing having a main body and a cover, and a stability cage at least partially enclosing the battery cells and positioned between the battery cells and the battery housing. The stability cage may include a polymer frame having four sidewalls positioned in a rectangular form, wherein each sidewall includes a plurality of apertures forming a mesh pattern.

### BRIEF DESCRIPTION OF THE DRAWINGS

FIG. 1 illustrates a side view of a battery having a thermal resin layer positioned along substantially the entire length of a bottom surface of a cover of a housing of the battery; an associated battery management system includes several metal plates contacting the thermal resin layer, in accordance with one aspect of the present disclosure.

FIG. 2 illustrates a side view of a battery having a thermal resin layer positioned along select sections of a bottom surface of a cover of a housing of the battery; an associated battery management system includes several metal plates contacting the thermal resin layer sections, which does not extend in a lateral direction beyond the edges of the metal plates, in accordance with one aspect of the present disclosure.

FIG. 3 illustrates a side view of a battery having a thermal resin layer positioned along a section of a bottom surface of a cover of a housing of the battery; an associated battery management system includes a printed circuit board (PCB) contacting the thermal resin layer, which extends in a lateral direction beyond the edges of the PCB but does not cover the entire length of the bottom surface of the battery housing cover, in accordance with one aspect of the present disclosure.

FIG. 4 illustrates a side view of a battery having a thermal resin layer positioned along a section of a bottom surface of a cover of a housing of the battery; an associated battery management system includes a printed circuit board and multiple field-effect transistors (FETs) both in contact with the thermal resin, which extends in a lateral direction beyond the edges of the PCB but does not cover the entire length of the bottom surface of the battery housing cover, in accordance with one aspect of the present disclosure.

FIG. 5A illustrates a bottom view of a battery housing cover having a thermal resin layer positioned along a large portion of its bottom surface; an associated battery management system includes several metal plates contacting the thermal resin layer, in accordance with one aspect of the present disclosure.

FIG. 5B illustrates a perspective view of the battery housing cover of FIG. 5A.

FIG. 6 is a process flowchart for a method of manufacturing a battery configured to have improved stability, in accordance with one aspect of the present disclosure.

FIG. 7A illustrates a partial exploded view of a battery housing and an associated battery stability cage, in accordance with one aspect of the present disclosure.

FIG. 7B illustrates a partial cutaway view of the battery housing and the battery stability cage of FIG. 7A, along with an associated battery management system and thermal epoxy layer, in accordance with one aspect of the present disclosure.

FIG. 7C illustrates an isometric view of the battery stability cage of FIGS. 7A-7B, in accordance with one aspect of the present disclosure.

FIG. 7D illustrates a front view of the battery stability cage of FIGS. 7A-7C, in accordance with one aspect of the present disclosure.

FIG. 7E illustrates a side view of the battery stability cage of FIG. 7A-7D, in accordance with one aspect of the present disclosure.

FIG. 8 illustrates a side view of a battery pack construction having multiple battery cell spacers positioned at three points between each battery cell, with two adhesive tape sections wrapped around the battery pack in-between the battery cell spacers, in accordance with one aspect of the present disclosure.

FIG. 9 is a process flowchart for a method of manufacturing a battery configured to have improved stability, in accordance with one aspect of the present disclosure.

FIG. 10 illustrates a perspective view of a battery cell having a pouch form, in accordance with one aspect of the present disclosure.

FIG. 11 illustrates a perspective view of a battery pack formed of several battery cells with interconnects providing electrical communication pathways between the battery cells, in accordance with one aspect of the present disclosure.

FIG. 12 illustrates a side view of a battery pack construction having multiple battery cell spacers extending along substantially the entire length of the battery cells, in accordance with one aspect of the present disclosure.

FIG. 13 illustrates a perspective view of a battery pack construction formed of several battery cells with a layer of adhesive taping enclosing the entire battery pack, including the battery cells and the battery cell spacers, if any, in accordance with one aspect of the present disclosure.

FIG. 14 illustrates a perspective view of the battery pack construction of FIG. 13 further enclosed in protective plates positioned along several geometric sides of the battery pack construction, in accordance with one aspect of the present disclosure.

FIG. 15 illustrates a perspective view of the battery pack construction of FIG. 14 further enclosed in a second layer of adhesive tape, which may help to further secure the protective plates to the first layer of adhesive tape and ensure the stability of the battery pack, in accordance with one aspect of the present disclosure.

FIG. 16 illustrates a perspective view of the battery pack construction of FIG. 15 at least partially enclosed in a shrink-wrapped polymeric film, in accordance with one aspect of the present disclosure.

The current subject matter will be better understood by reference to the following detailed description when considered in combination with the accompanying drawings which form part of the present specification.

### DETAILED DESCRIPTION

Unless specifically stated or apparent from context, as used herein, the terms “a”, “an”, and “the” are understood to be singular or plural. The terms “include(s)” or “such as,” and the like are intended to convey inclusion without limitation, unless otherwise specifically indicated. The terms “or” and “and” can be used interchangeably and can be understood to mean “and/or.”

As used herein, the term “substantially” refers to the qualitative condition of exhibiting total or near-total extent or degree. Substantially may refer to a minimum degree understood in the art. For example, substantially all of a value (e.g. an area of a surface) may refer to at least 80%, at least 85%, at least 90%, at least 95%, or specifically at least 99% of that value.

As used herein “battery management system” (BMS) may refer to a group of battery components that manage a rechargeable battery, often by preventing the battery from operating outside of its safe operating area. Various constructions of battery management systems are disclosed, for example, in U.S. Pat. App. Pub. 2022/0209307 entitled “Lithium-Ion Battery Management System (BMS) Having Diagonal Arrangement,” the contents of which are incorporated herein by reference in their entirety.

As used herein “thermal epoxy” may refer to a polymer resin that has a viscosity that allows it to be poured and has a high thermal conductivity. Thermal epoxy may be used as a generic term herein, and does not necessarily indicate the composition of the product unless context specifically indicates otherwise. For instance, a thermal epoxy, as used herein, need not necessarily be formed from polyepoxides, but may instead comprise alternative or additional polymer resins, such as urethanes.

### Battery Management System Heat Transfer

The battery management system in a lithium-ion battery requires electronic circuitry to disconnect the internal battery pack from the external battery terminals in case of a fault condition. This circuitry can dissipate a significant amount of power which generates heat that needs to be dissipated to the exterior of the battery housing. Due to exposure concerns, such BMS systems are often enclosed in a battery housing that contains limited, if any, external venting to provide airflow. Since the removal of heat through the limited natural convection occurring within a battery housing can be slow, such constructions can result in stagnant hot air within battery housings. This stagnant hot air can accumulate near the BMS until the heat eventually transfers from the internal air to the battery housing cover and then to the external environment.

The present disclosure provides battery systems that allow for the direct and efficient transfer of heat from the heat generating components of a BMS to the battery housing via a thermal resin conduction pathway, such as through an applied thermal epoxy layer. By providing a direct conduction pathway instead of relying on the limited natural convection typically available within a battery housing, a more efficient heat removal construction can be achieved. Furthermore, by relying on a thermally conductive viscous liquid that can be poured or injected to take the shape of the surfaces it covers, thermal contact over large areas of a BMS can be achieved, even for irregularly shaped components. Because of the improved heat transfer, battery systems incorporating the teachings of the present disclosure may be able to operate at higher currents for similarly sized constructions.

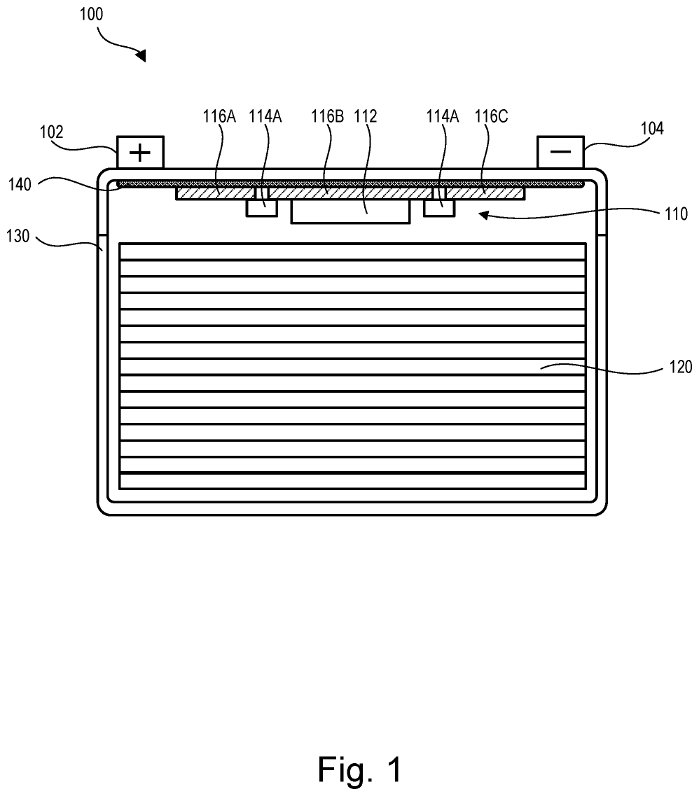

Accordingly, a battery configured to have improved stability may be provided, wherein the battery has a battery management system in electrical communication with a plurality of battery cells, a battery housing enclosing the battery cells and the BMS, and a thermal epoxy contacting one or more thermal components and the battery housing. The thermal components of the BMS may be specifically configured to disperse heat from the BMS. For example, the one or more thermal components in contact with the thermal epoxy may include an electrical component configured to generate heat when subjected to an electric current, such as a field-effect transistor (FET), or more specifically, a metal-oxide semiconductor field-effect transistor (MOSFET). Alternatively, the one or more thermal components in contact with the thermal epoxy may include a conductive component, such as a metal (e.g. copper) plate. Such a metal plate may be in contact with an electrical component (e.g. MOSFET) configured to generate heat when subjected to an electric current. FIGS. 1-5B illustrate various battery arrangements that allow for conductive heat transfer from a BMS in an enclosed battery system.

FIG. 1 illustrates a battery 100 configured to have improved stability. The battery 100 may have a positive battery terminal 102 and a negative battery terminal 104. The battery 100 may include a battery management system 110 in electrical communication with multiple battery cells 120. The BMS 110 may have a printed circuit board 112 and one or more thermal components configured to disperse heat from the BMS 110, such as the depicted MOSFETs 114A, 114B and metal plates 116A, 116B, 116C. A battery housing 130 may enclose the battery cells 120 and the BMS 110. A thermal epoxy layer 140 may be at least partially interposed between and contacting the metal plates 116A, 116B, 116C and the battery housing 130. As shown, the thermal resin layer 140 may substantially cover an entire bottom surface of a cover of the battery housing 130, which may allow for sufficient dispersion of energy away from the metal plates 116A, 116B, 116C and the BMS 110.

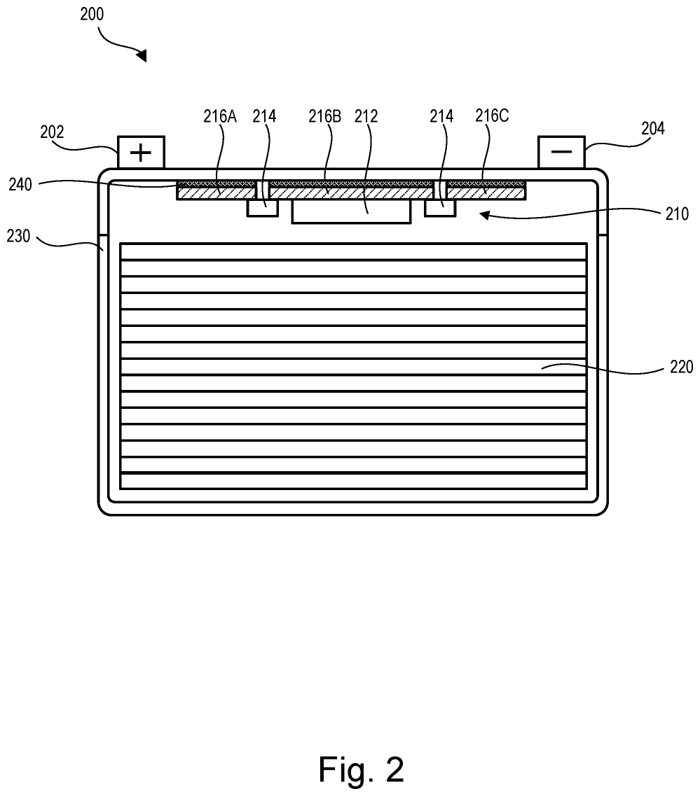

FIG. 2 illustrates a battery 200 also configured to have improved stability with an alternative thermal epoxy arrangement compared to the battery 100 of FIG. 1, which shares many of the same components with the battery 200. For instance, the battery 200 also may include a positive battery terminal 202, a negative battery terminal 204, multiple battery cells 220, a battery housing 230, a thermal epoxy layer 240, and a BMS 210 having a printed circuit board 212, multiple MOSFETS 214A, 214B, and metal plates 216A, 216B, 216C. However, unlike the thermal epoxy layer 140 in battery 100 of FIG. 1, the thermal epoxy 240 of the battery 200 may not extend in a lateral direction beyond the edges of the metal plates 216A, 216B, 216C of the BMS. Rather, the thermal epoxy 240 may be substantially restricted to the area of the metal plates 216A, 216B, 216C, which may allow for adequate thermal transfer from the metal plates 216A, 216B, 216C without excess thermal resin being included.

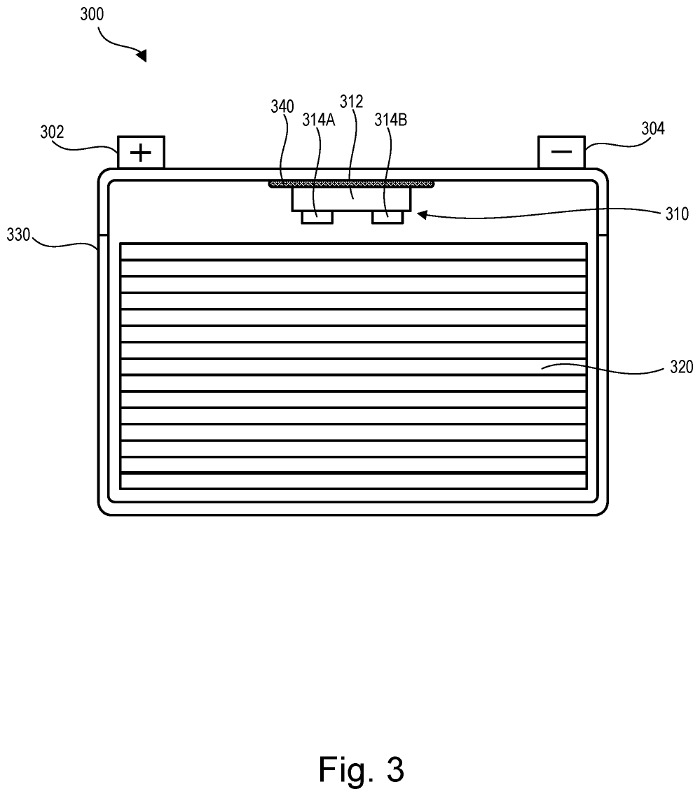

FIG. 3 illustrates a battery 300 also configured to have improved stability with an alternative thermal epoxy arrangement compared to the batteries 100, 200 of FIGS. 1, 2, which share many of the same components with the battery 300. For instance, the battery 300 also may include a positive battery terminal 302, a negative battery terminal 304, multiple battery cells 320, a battery housing 330, a thermal epoxy layer 340, and a BMS 310 having a printed circuit board 312 and multiple MOSFETs 314A, 314B. However, unlike in prior depictions, the BMS 310 may not include metal plates, but may instead rely on heat transfer from the MOSFETs 314A, 314B to the thermal resin layer 340 through the PCB 312, on the bottom side of which the MOSFETs 314A, 314B are positioned. Furthermore, as shown, the thermal epoxy layer 340 may extend in a lateral direction beyond the edges of the PCB 312, but may not take up an entire bottom surface of a cover of the battery housing 330.

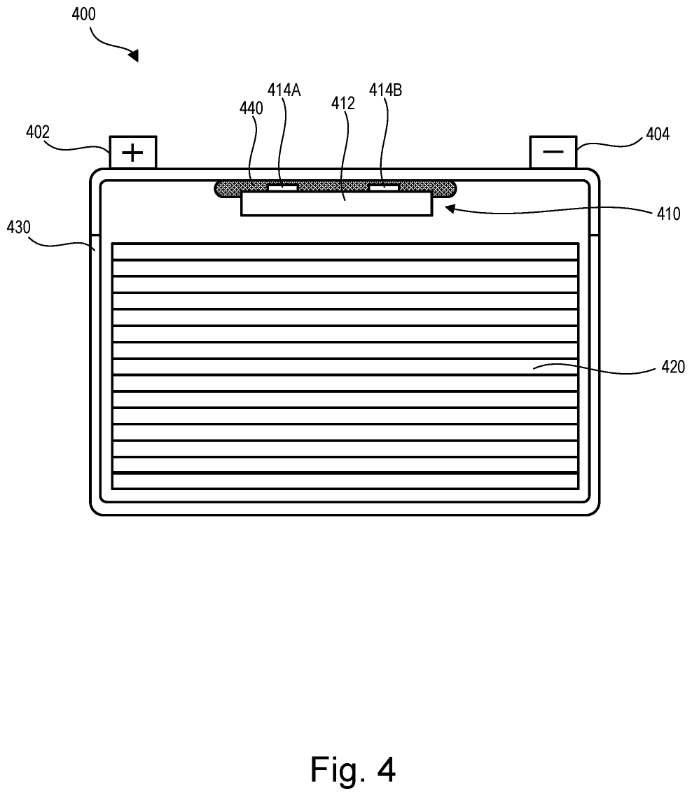

FIG. 4 illustrates a battery 400 also configured to have improved stability with an alternative thermal epoxy arrangement compared to the battery 300 of FIG. 3, which shares many of the same components with the battery 400. For instance, the battery 400 also may include a positive battery terminal 402, a negative battery terminal 404, multiple battery cells 420, a battery housing 430, a thermal epoxy layer 440, and a BMS 410 having a printed circuit board 412 and multiple MOSFETs 414A, 414B. However, unlike in prior depictions, the MOSFETs 414A, 414B and the PCB 412 may be in direct contact with the thermal resin layer 440. Because the thermal epoxy layer may have direct contact with the heat generating MOSFETs 414A, 414B, thermal energy may be more easily transferred outside of the battery 400.

The application of the thermal epoxy layers 140, 240, 340, 440 can be important to the performance and durability of the respective batteries 100, 200, 300, 400. Generally, the thermal epoxy layer may be constructed to avoid air gaps, thereby providing direct contact between the BMS and the battery housing. As described, the thermal epoxy layer may cover the entire underside of the battery housing cover, may be placed only underneath the copper plates or PCB, or may be limited to smaller areas where the most heat is generated. Rather than include polyepoxides, the thermal epoxy layer may be instead formed of urethane or another thermally conductive resin that has a viscosity that allows it to be poured into the area between the BMS and the battery housing in order to provide a thermal conduction pathway. In order to provide sufficient heat transfer, the thermal epoxy may have a thermal conductivity of at least 0.8 W/mK, at least 1 W/mK, or more specifically about 1.2 W/mK.

In order to provide improved structural stability and prevent movement during shock and vibration, it has been recognized that the use of a rigid epoxy may prevent damage to the BMS system when the battery is subjected to exterior forces. In this manner, the introduction of a rigid thermal epoxy provides both structural stability and thermal stability to the battery system. Specifically, a rigid thermal epoxy may be used that has a cured hardness of at least 70 Shore A, at least 75 Shore A, at least 80 Shore A, or more specifically between 85 and 90 Shore A. Furthermore, the rigid thermal epoxy may have a tensile strength of at least 15 N/mm², at least 20 N/mm², or specifically about 23 15 N/mm².

When the MOSFETs are embedded into a rigid thermal epoxy, it has been recognized through experimentation that they may become damaged over time due to thermal cycling. The MOSFETs, metal plates, and thermal epoxy may all have different coefficients of thermal expansion, which can cause stresses on the MOSFETs and crack their leads. As a result, when a rigid thermal epoxy is used, it may specifically be arranged so as to contact only the metal plates of the BMS, but not the MOSFETS themselves. Conversely, a soft thermal epoxy may be specifically used in constructions where the thermal epoxy layer contacts the MOSFETs in order to avoid damage to the BMS, and the thermal epoxy layer may even substantially cover the entire BMS. A soft thermal epoxy may be a thermal epoxy that has a cured hardness of less than 60 Shore A, less than 50 Shore A, or more specifically less than 40 Shore A. In this manner, depending on the properties of the epoxy used, the heat generating components (e.g. MOSFETs) of the BMS may be mounted facing downward away from the thermal epoxy, or they may be mounted facing upward into the thermal epoxy.

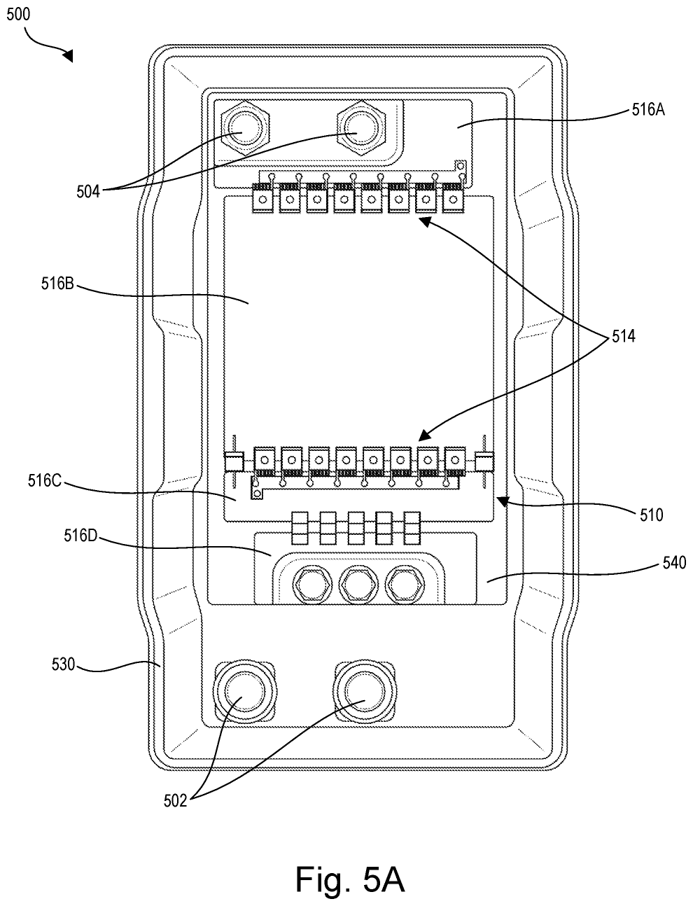

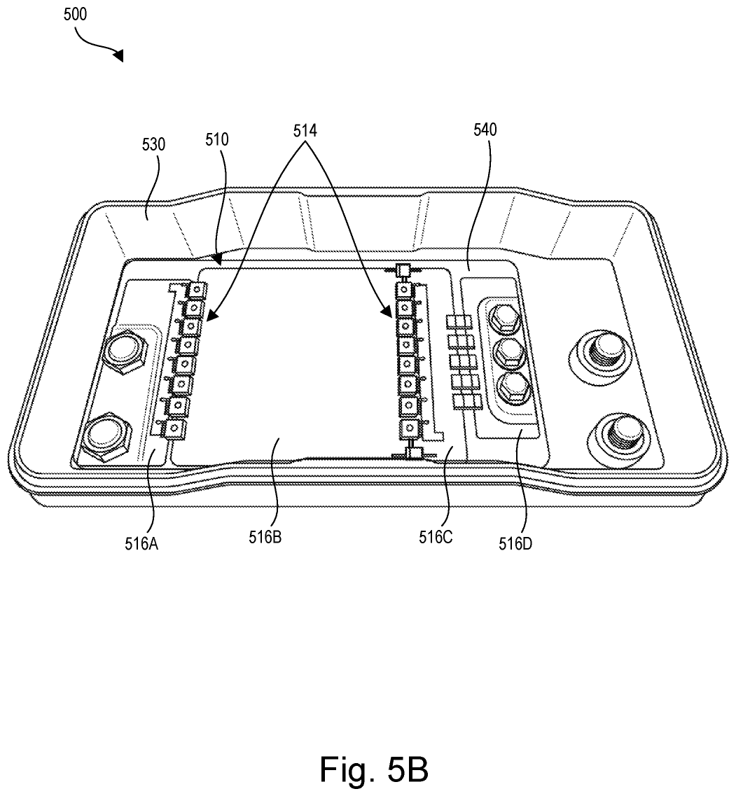

FIGS. 5A-5B illustrates a battery housing cover arrangement 500 and select components of a BMS 510 in contact with a thermal epoxy layer 540. The battery housing cover arrangement 500 is similar to the arrangements in the batteries 100-400 of FIGS. 1-4, which share many of the same components. For instance, the battery housing cover arrangement 500 may include positive battery terminals 502, negative battery terminals 504, a battery housing cover body 530, which may or may not be configured to be easily removed, and a thermal epoxy layer 540. The BMS 510 may include multiple MOSFETs 514 (two groupings of eight MOSFETs) and multiple metal plates 516A, 516B, 516C, 516D. As shown, the thermal resin layer 540 may contact a large portion of the battery housing cover 530 and be in direct contact with all four metal plates 516A, 516B, 516C, 516D, but not in contact with the MOSFETs 514. In this manner, the thermal epoxy layer 540 may not be in contact with the electrical components configured to generate heat, which are the MOSFETs 514 in this depiction. Generally, the MOSFETs 514 may generate heat from electrical current passing through them, which is first transferred to the series of metal plates 516A, 516B, 516C, 516D, then to the thermal resin layer 540 through the metal plates 516A, 516B, 516C, 516D, and then finally to the battery housing cover 530.

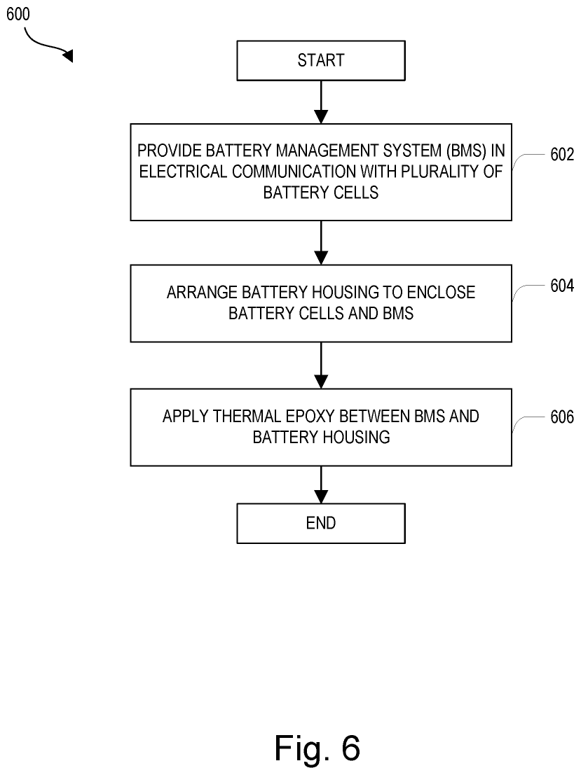

FIG. 6 depicts a method 600 of manufacturing a battery configured to have improved stability, consistent with the battery arrangements depicted in FIGS. 1-5B. At 602, a battery management system in electrical communication with a plurality of battery cells may be provided. The BMS may have one or more thermal components configured to disperse heat from the BMS. At 604, a battery housing may be arranged to enclose the battery cells and the BMS. At 606, a thermal epoxy may be applied between the BMS and the battery housing. The thermal epoxy may contact the one or more thermal components and the battery housing.

### Battery Stability Cage

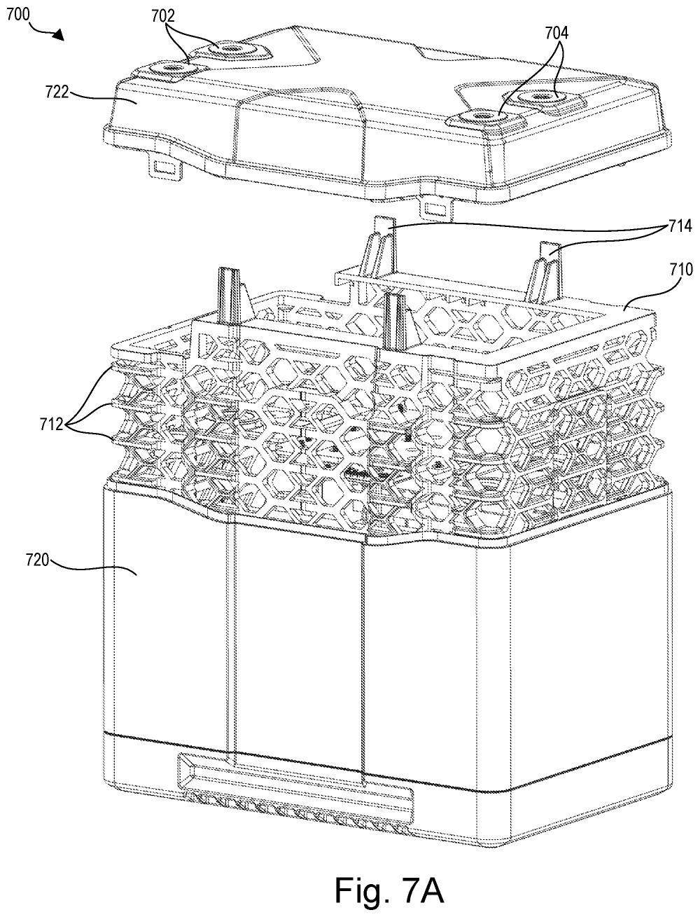

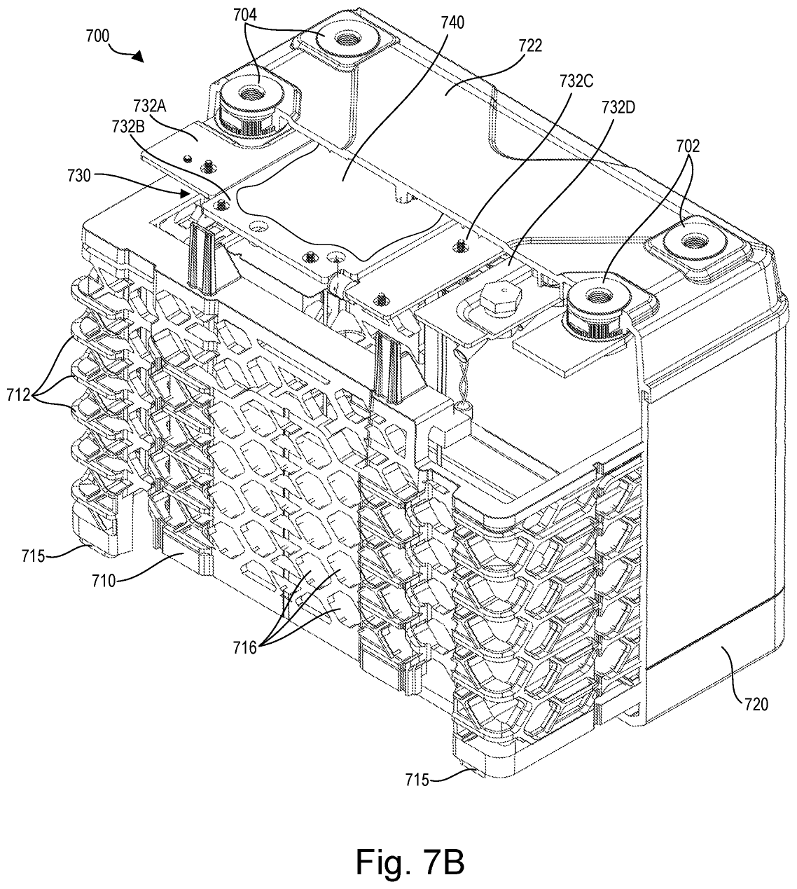

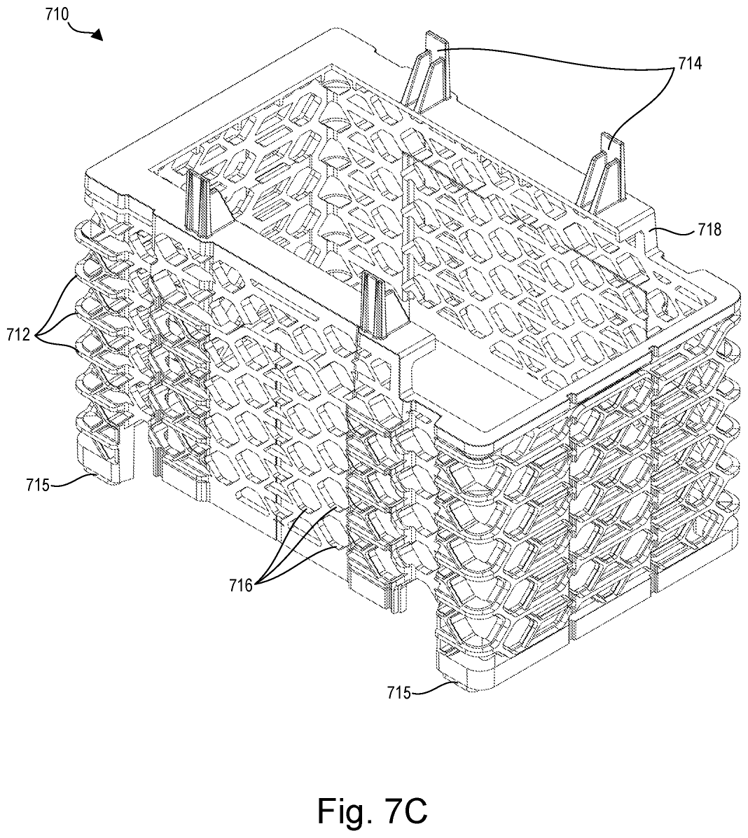

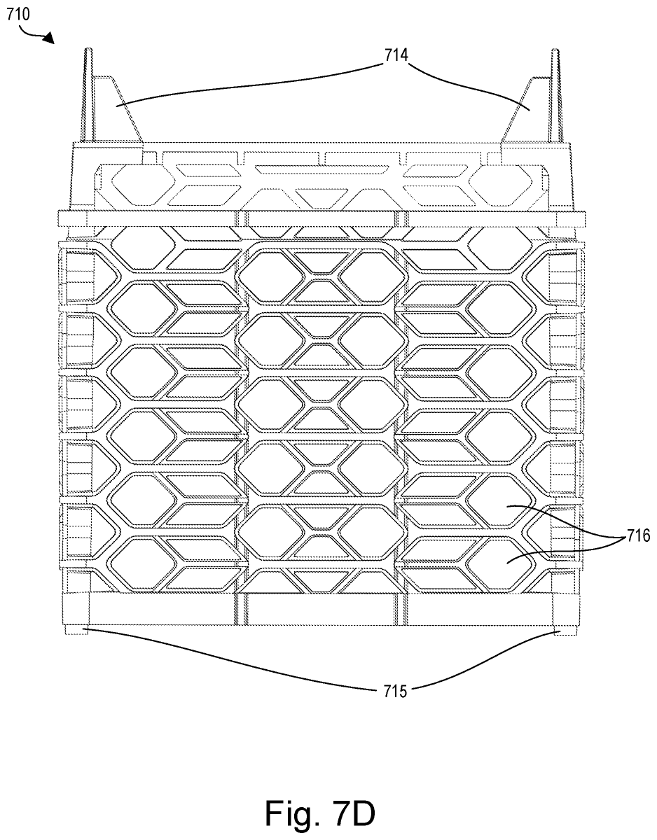

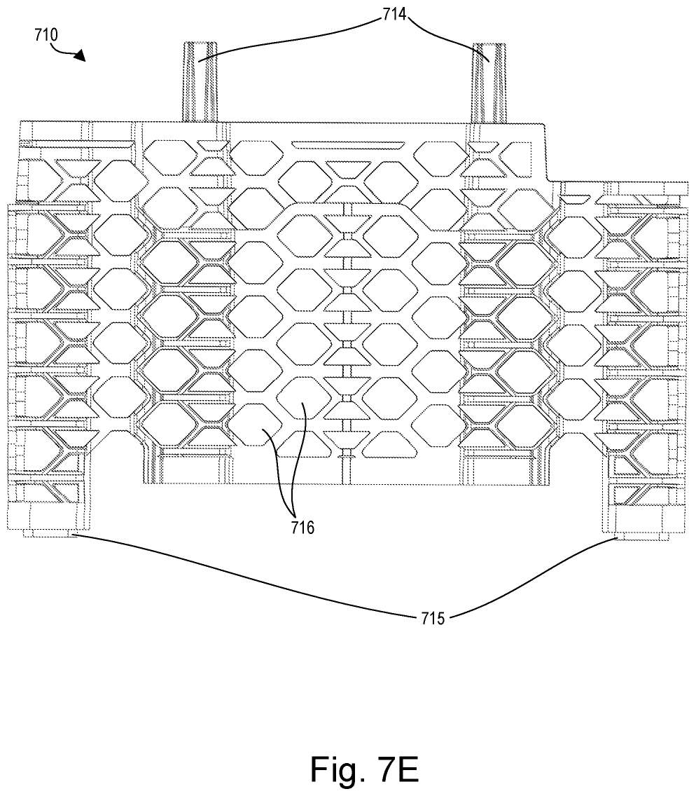

In order to improve the mechanical stability of battery pack within an enclosed battery system, a battery stability cage is provided herein. An example configuration of the battery stability cage is depicted in FIGS. 7A-7E. The stability cage may include features and may be positioned between a battery housing and a battery pack in such a manner that external forces on the exterior of the battery are less likely to damage the battery cells of the battery pack.

As shown in the partial exploded view of various components 700 of a battery of FIG. 7A, as well as in FIGS. 7B-7D, a battery stability cage 710 may partially enclose an interior area for a battery pack containing a plurality of battery cells, which may be connected to a positive battery terminal 702 and a negative battery terminal 704. The stability cage 710 may be positioned between the area for the battery cells and the battery housing, including the battery housing body 720 and a battery housing cover 722.

As shown, the battery stability cage 710 may be polymer frame having four sidewalls positioned in a rectangular form with a variety of specific structural features that allow the battery stability cage 710 to protect the battery cells and connect to the other components of the battery. For instance, as shown, each sidewall of the battery stability cage 710 may include a plurality of apertures 716 forming a mesh pattern, which provides adequate structural stability without adding excess material and weight to the battery. The apertures 716 may specifically include hexagonal shaped apertures, or alternatively include comparable structurally cutouts. The polymer frame may include a plurality of horizontal supports 712 positioned along each corner of the polymer frame. As shown, the horizontal supports 712 may at least partially protrude outward from the surface of at least one of the sidewalls immediately adjacent to the corner.

The battery stability cage 710 may also include one or more cover attachment mechanisms 714 configured to connect the stability cage to the battery housing cover 722. In embodiments, the cover attachment mechanisms 714 may connect with the battery housing cover 722 using a tongue and groove configuration. In order to secure the battery stability cage 710 to the housing body 720, body attachment mechanisms 715 may be included near the bottom of the stability cage, as shown. In embodiments, the body attachment mechanisms 715 may connect with the housing body 720 using a tongue and groove configuration. In order to further secure the battery stability cage 710 in place, an adhesive may be further applied to the attachment mechanisms 714, 715 in order to secure their connection to the respective housing components. Furthermore, additional adhesive or mechanical attachment forms may be provided along the sides of the battery stability cage 710 in order to further ensure a solid connection to the housing body 720.

FIG. 7B illustrates a partial cutaway view of the battery housing and the battery stability cage 710 of FIG. 7A, along with an associated battery management system 730 and thermal epoxy layer 740. As shown, the BMS 730 may include four electrically connected metal plates 732A, 732B, 732C, 732D. The thermal epoxy layer 740 may contact only a portion of metal plate 732B, which may be in contact with all of the BMS electrical components configured to generate heat the energy. The BMS 730 may be positioned above the battery stability cage 710 but be enclosed within the battery housing cover 722 and battery housing body 720.

FIGS. 7C-7E depict various views of the battery stability cage 700. Although the depicted battery stability cage 710 is formed of substantially four side walls, it should be appreciated that the stability cage 710 may further include a bottom wall or a top wall. As shown in FIG. 7C, the stability cage 710 may have a top lip 718 or similar component. The top lip 718 may be configured to prevent an enclosed battery pack from moving in an upward direction. As shown, the top lip 718 may thus help to prevent an enclosed battery pack from contacting or damaging a BMS system positioned above the battery pack or damaging the battery pack. A force absorbing component, such as a foam pad, may be positioned in between the battery stability cage 710 and the housing body 720 in order to provide further mechanical stability of any enclosed battery cells.

### Battery Pack Construction

Because battery packs are formed of multiple battery cells, the specific arrangement and connections between battery cells is important for preventing battery failures resulting from external forces. In particular, when a battery pack is formed of stacked pouch-type battery cells, it has been recognized through experimentation that movement (e.g. sliding due to vibration) or inconstant forces on the battery pouches can lead to failure. Accordingly, the present disclosure provides a battery pack construction and method of forming the same that has improved structural integrity. In particular, the battery pack construction may restrain the battery cells and prevent movement by providing even pressure across the surfaces of the battery pack. Additionally, spacers with adhesive components may further help to limit the movement of the battery cells.

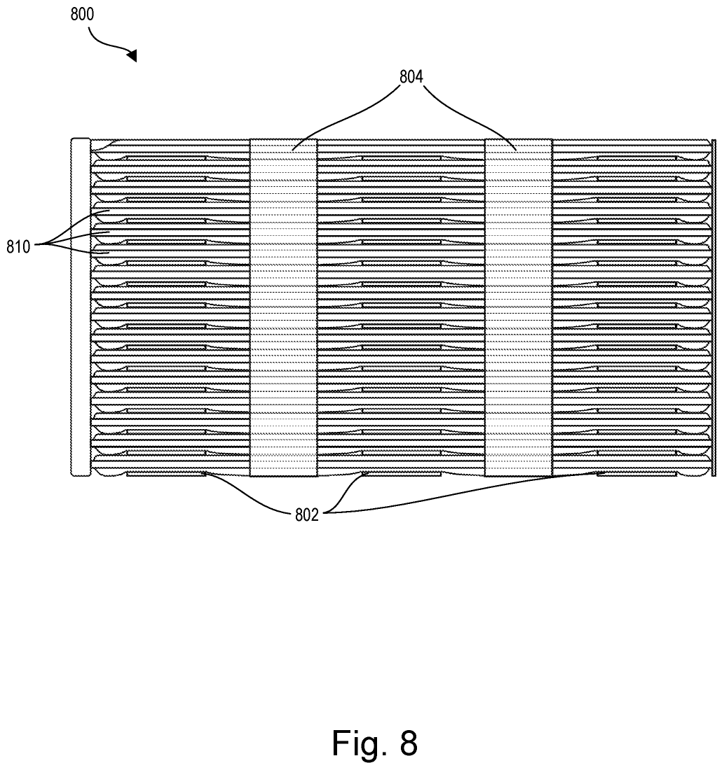

FIG. 8 depicts a wrapped battery pack construction 800 with three sets of spacers 802 positioned in left, center, and right columns, the spacers 802 are generally included to separate the battery cells 810 and promote thermal dissipation. The battery pack construction 800 also includes two adhesive tape sections 804 located between the columns of spacers 802 and configured to secure the battery cells 810 together in a rigid construction. It has been recognized through experimentation that the battery pack 800, with the inconsistent forces provided by the battery cells spacers 802 and the adhesive tape sections 804, can produce movement and deformation of the cells during vibration, which can eventually cause internal damage and rupturing of the cells. Specifically, if has been recognized through experimentation that the battery cells 810 remain together along the adhesive tape sections 804, but can become deformed in between the tape sections 804 where the spacers 802 are located. Accordingly, the present disclosure addresses these drawbacks by providing a battery pack construction that produces more consistent forces during vibration and prevents internal movement of battery cells.

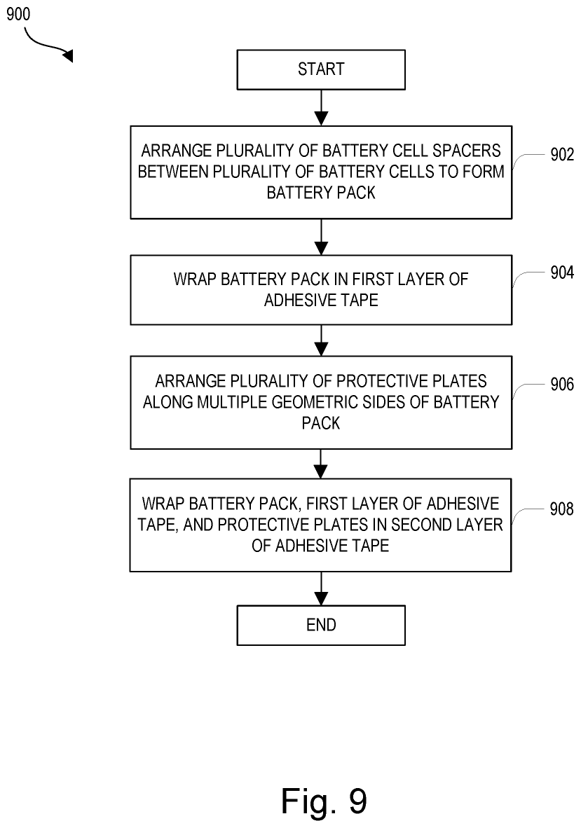

FIG. 9 depicts a method 900 of manufacturing a battery configured to have improved stability. At 902, a plurality of battery cell spacers may be arranged between a plurality of battery cells to form a battery pack. In order to produce consistent forces along the surface of each battery cell, each battery cell spacer may be configured to contact substantially all of each adjacent battery cell surface. At 904, the battery pack may be wrapped in a first layer of adhesive tape. The first layer of adhesive tape may contact substantially all of multiple geometric sides of the battery pack. At 906, a plurality of protective plates may be arranged along the multiple geometric sides of the battery pack. The protective plates may be positioned and configured to substantially cover the multiple geometric sides. At 908, the battery pack, the first layer of adhesive tape, and the protective plates may all be wrapped in a second layer of adhesive tape. Although not depicted, the method may further include shrink wrapping the battery pack, the first layer of adhesive tape, the protective plates, and the second layer of adhesive tape in a polymeric film.

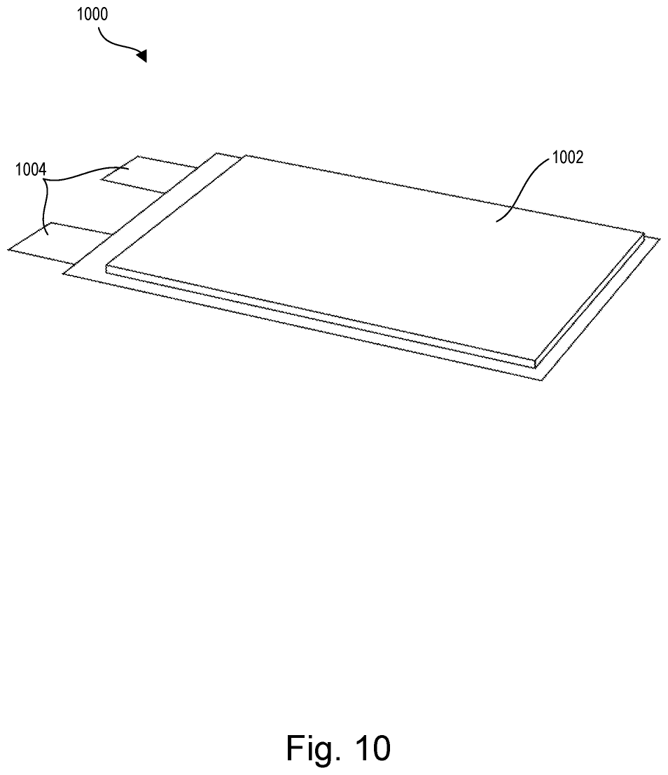

FIG. 10 depicts an example battery cell 1000 having a pouch form, which may be stacked with other similar battery cells to form a battery pack, consistent with the method 900. The battery cell 1000 may be connected in series, in parallel, or in a combination of series and parallel with other battery cells. As shown, the battery cell has a body 1002 that is substantially flat, having a length and a width considerably longer than its height. Specifically, the battery cell body 1002 may have a length and a width that are both at least 5 times the value of its height. The battery cell 1000 also may have a number of connectors 1004 configured to interconnect the battery cell 1000 to other battery cells as well as battery terminals. The battery cell 1000 may specifically be a lithium-ion cell.

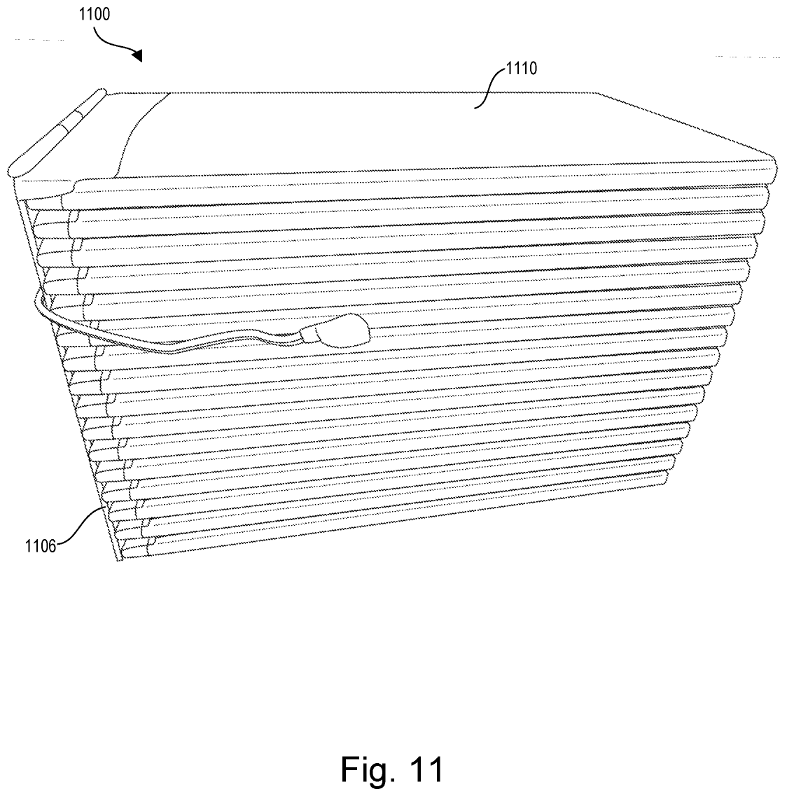

FIG. 11 illustrates a perspective view of a battery pack 1100 formed of several battery cells 1110 with interconnects 1106 providing electrical conductivity between the battery cells 1110. The depicted battery pack has 16 battery cells stacked together. However, it should be recognized that an alternative number of battery cells may be readily used depending on the intended application, and that the battery cells 1110 could take an alternative arrangement (e.g. multiple side-by-side stacks).

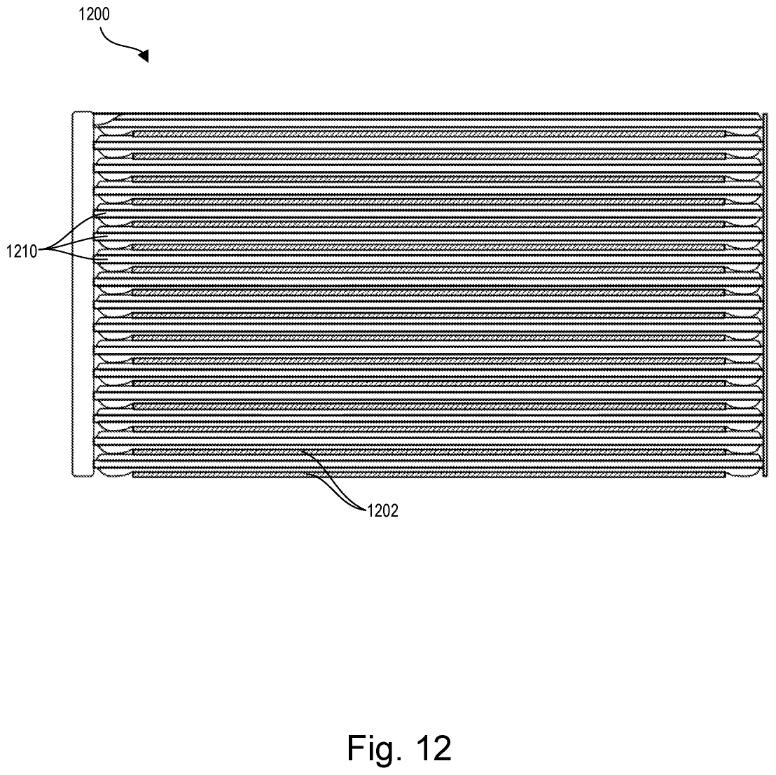

FIG. 12 illustrates a side view of another battery pack 1200 having multiple battery cell spacers 1202 extending along substantially the entire length of the battery cells 1210. Accordingly, each of the battery cells 1210 may have a top surface and a bottom surface, and each of the battery cell spacers 1202 may have a first surface contacting substantially all of the bottom surface of an adjacent battery cell and a second surface contacting substantially all of the top surface of another adjacent battery cell. For instance, the battery cell spacers 1202 may contact at least 80%, at least, 90%, or specifically at least 95% of the adjacent battery cells. In this manner, each battery cell pairing may have only one battery cell spacer positioned therebetween. Each of the battery cell spacers 1202 may have a smaller thickness than the thicknesses of each of the battery cells 1210.

The battery cell spacers 1202 may each have at least one adhesive component configured to engage with and attach to the surface of adjacent battery cells to prevent movement of the battery cells 1210. The adhesive component may cover a portion of one surface of the battery cell spacers 1202, or may cover substantially all of one surface of the battery cell spacers 1202. Each of the battery cell spacers 1202 may each include at least two adhesive components, a first adhesive component positioned on a top surface and a second adhesive component positioned on a bottom surface of each the battery cell spacers 1202. By providing adhesive components affixing each of the battery cell spacers 1202, each of the battery cells 1210 may be prevented from sliding or moving within the battery pack relative to each other or to the battery cell spacers 1202. The adhesive components may specifically include double-sided adhesive tape, an adhesive paste or glue, or a similar form of adhesive attachment.

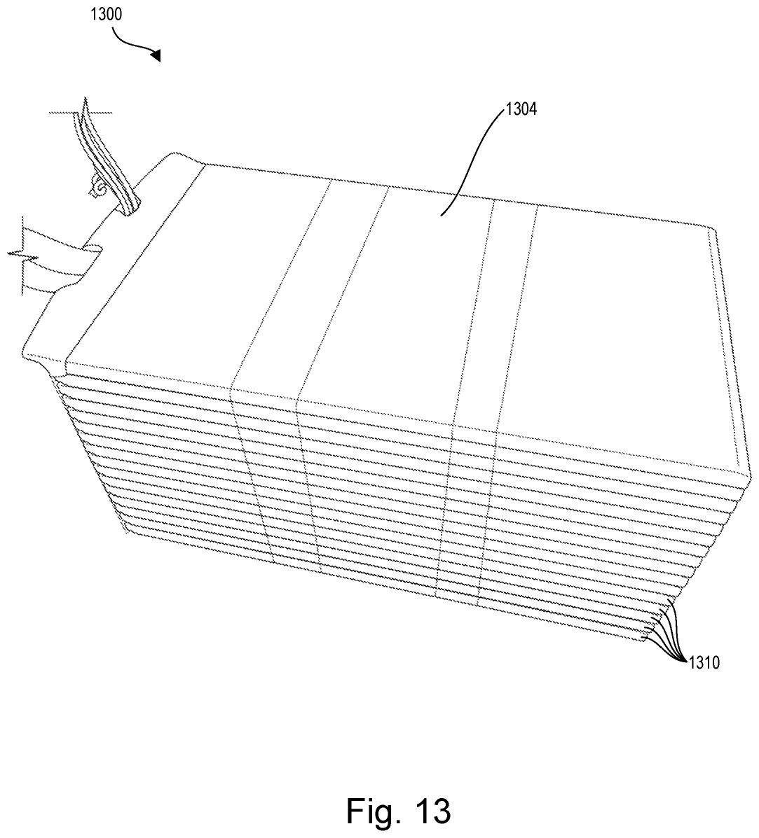

FIG. 13 illustrates a perspective view of a battery pack construction 1300 formed of several battery cells 1310 with a layer of adhesive taping 1304 enclosing the entire battery pack, including the battery cells 1310 and any battery cell spacers that may be optionally included. By providing a consistent layer of adhesive taping 1304, rather than individually spaced tape loops, the battery cells 1310 may experience more evenly applied pressure, and therefore may be less likely to fail. The adhesive taping 1304 may be provided as one single layer of tape, or by multiple overlapping layers, as shown. The adhesive taping 1304 may contact substantially all of the top surface of the battery pack construction 1300, substantially all of at least four surfaces of the battery pack construction 1300, or substantially all six sides of the battery pack construction 1300.

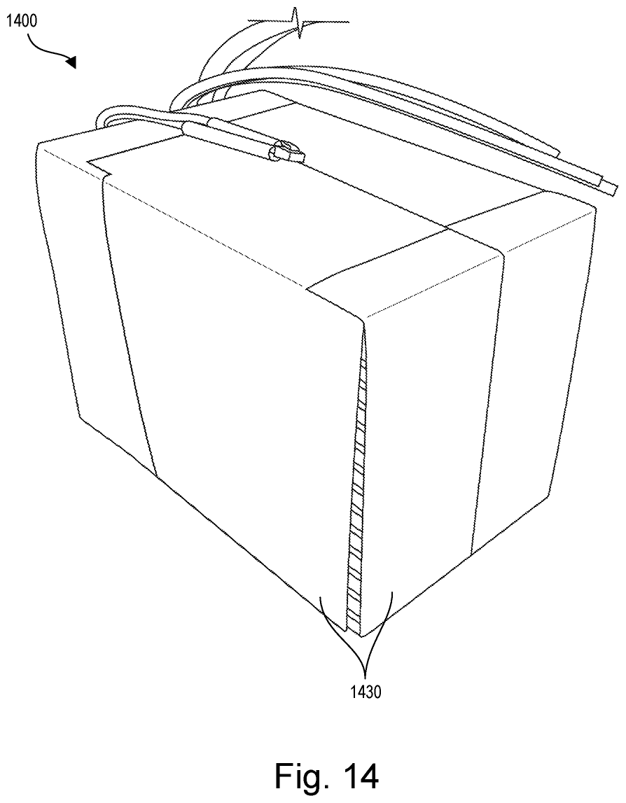

FIG. 14 illustrates a perspective view of the battery pack construction 1300 of FIG. 13 further enclosed in protective plates 1430 positioned along each geometric side of the new battery pack construction 1400. The protective plates 1430 may be formed of metal, such as aluminum. Alternatively, the protective plates 1430 may be formed of a hard plastic, such as phenolic or similar material. The protective plates 1430 may be connected, such that one large metal plate is bent to form each of the separate metal plates 1430. Instead, the protective plates 1430 may be formed of disconnected individual plates corresponding to each side of the battery pack construction 1400. The protective plates 1430 may be configured to contact and protect substantially all of the top surface of the battery pack construction 1400, substantially all of at least four surfaces of the battery pack construction 1400, or substantially all six sides of the battery pack construction 1400.

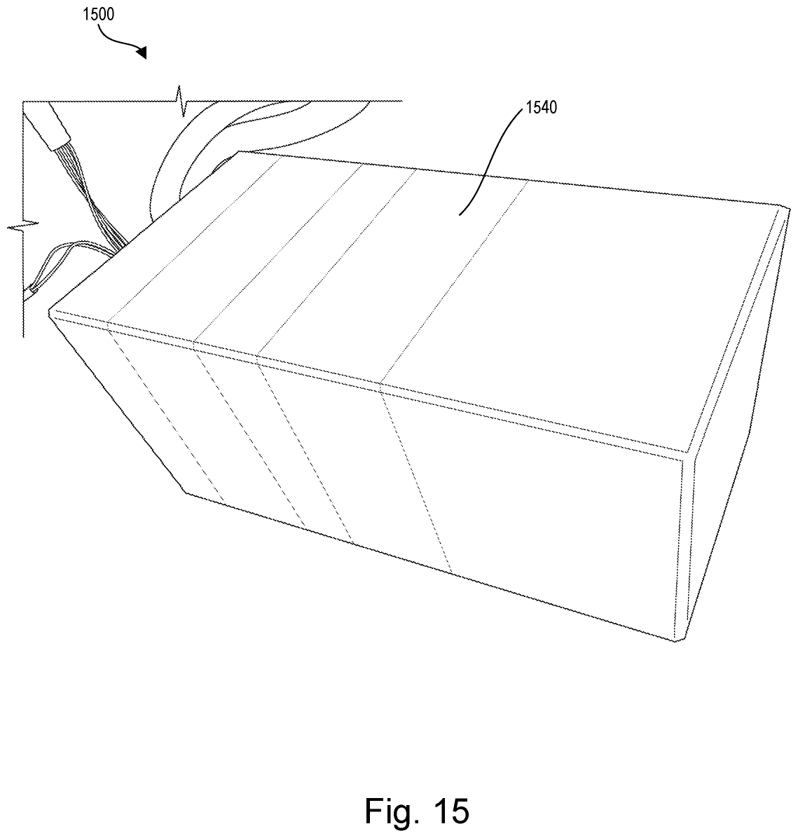

FIG. 15 illustrates a perspective view of the battery pack construction 1400 of FIG. 14 further enclosed in a second layer of adhesive tape 1540, which may help to further secure the protective plates 1430 to the first layer of adhesive tape 1304 and ensure the stability of the new battery pack construction 1500. Similar to the first layer of adhesive tape 1304, the second layer of adhesive tape 1540 may be provided as one single layer of tape, or by multiple overlapping layers, as shown. The adhesive taping 1540 may contact substantially all of at least the top surface of the battery pack construction 1500, substantially all of at least four surfaces of the battery pack construction 1500, or substantially all six sides of the battery pack construction 1500.

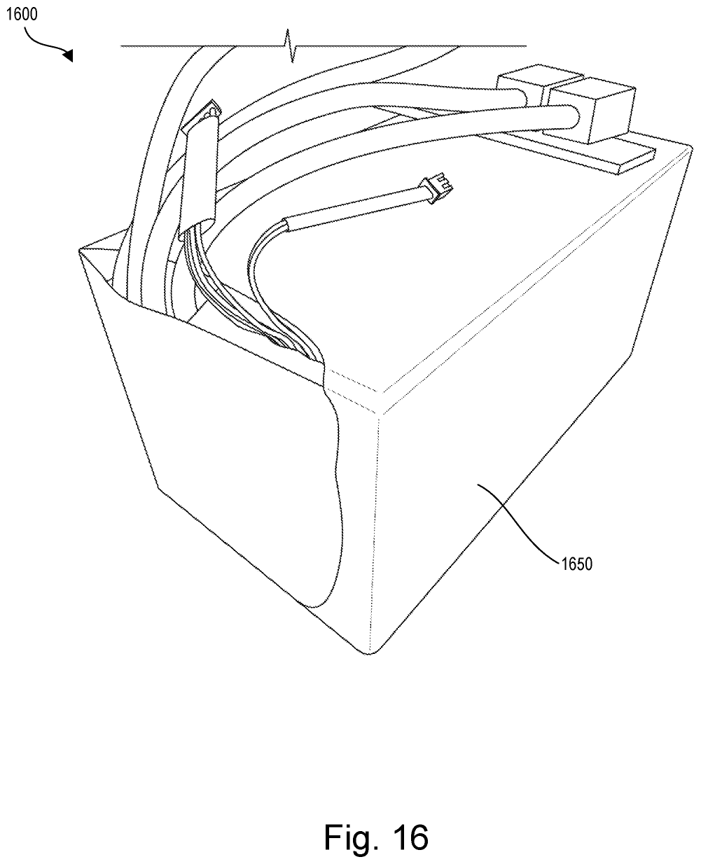

FIG. 16 illustrates a perspective view of the battery pack construction 1500 of FIG. 15 at least partially enclosed in a shrink-wrapped polymeric film 1650, thereby forming a further protected new battery pack construction 1600. The shrink-wrapped polymeric film may be formed of polyolefin, polyvinyl chloride, polyethylene, polypropylene, or another similar composition. By shrink wrapping the battery pack construction 1500, an outer layer can be provided that substantially avoids gaps or holes along most of the battery pack construction 1600.

Although many of the different techniques and features for providing a battery configured to have improved stability have been discussed as individual aspects herein, it should be appreciated that any combination of such techniques and features is possible. For example, a battery according to the present disclosure may include the BMS thermal dispersion components, the battery stability cage, and the unique battery pack construction components. For instance, a battery may include a battery pack construction with battery cell spacers having surfaces contacting substantially all of the surfaces of adjacent battery cells with adhesive components, a battery stability cage, and a thermal epoxy contacting a battery housing and one or more thermal components of a BMS. By combining multiple configurations for superior thermal management and structural stability together, a battery with improved safety features can be produced.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. Other implementations may be within the scope of the following claims.

1. A battery configured to have improved stability, the battery comprising:
a battery pack construction including:
a first battery cell having a top surface and a bottom surface;
a second battery cell having a top surface and a bottom surface; and
a battery cell spacer having a first surface contacting substantially all of the bottom surface of the first battery cell and a second surface contacting substantially all of the top surface of the second battery cell, wherein the first and the second surfaces each include an adhesive component;
a battery management system (BMS) in electrical communication with the first and second battery cells, the BMS having one or more thermal components configured to disperse heat from the BMS;
a battery housing enclosing the battery pack construction and the BMS;
a thermal epoxy contacting the one or more thermal components and the battery housing; and
a stability cage at least partially enclosing the battery pack construction and positioned between the battery cells and the battery housing, the stability cage including:
a polymer frame having four sidewalls positioned in a rectangular form, wherein each sidewall includes a plurality of apertures forming a mesh pattern.

2. The battery according to claim 1, wherein the thermal epoxy is a rigid thermal epoxy having a hardness of at least 70 Shore A.

3. The battery according to claim 1, wherein the one or more thermal components in contact with the thermal epoxy include a metal plate, wherein the metal plate is in contact with an electrical component configured to generate heat when subjected to an electric current.

4. The battery according to claim 3, wherein the one or more components in contact with the thermal epoxy include two metal plates, and wherein a metal-oxide semiconductor field-effect transistor (MOSFET) is in electrical communication with both of the two metal plates.

5. The battery according to claim 1, wherein the metal plate is a copper plate.

6. The battery according to claim 1, wherein the battery pack construction further includes:
a first layer of adhesive tape enclosing the first battery cell, the second battery cell, and the battery cell spacer, wherein the first layer of adhesive tape contacts substantially all of the top surface of the first battery cell.

7. The battery according to claim 6, wherein the battery pack construction further includes:
a first protective plate having a top surface and a bottom surface, the bottom surface contacting the first adhesive tape layer in line with the top surface of the first battery cell.

8. The battery according to claim 7, wherein the battery pack construction further includes:
a second layer of adhesive tape enclosing the first battery cell, the second battery cell, the battery cell spacer, the first layer of adhesive tape, and the first protective plate, wherein the adhesive tape contacts substantially all of the top surface of the first protective plate.

9. The battery according to claim 1, wherein the stability cage further includes an attachment mechanism configured to connect the stability cage to the battery housing, the battery housing enclosing the battery frame and the plurality of battery cells.

10. A battery configured to have improved stability, the battery comprising:
a battery management system (BMS) in electrical communication with a plurality of battery cells, the BMS having one or more thermal components configured to disperse heat from the BMS;
a battery housing enclosing the battery cells and the BMS; and
a thermal epoxy contacting the one or more thermal components and the battery housing.

11. The battery according to claim 10, wherein the one or more thermal components in contact with the thermal epoxy include an electrical component configured to generate heat when subjected to an electric current.

12. The battery according to claim 10, wherein the electrical component is a metal-oxide semiconductor field-effect transistor (MOSFET).

13. The battery according to claim 10, wherein the one or more thermal components in contact with the thermal epoxy include a metal plate, wherein the metal plate is in contact with an electrical component configured to generate heat when subjected to an electric current.

14. The battery according to claim 13, wherein the one or more thermal components in contact with the thermal epoxy include two metal plates, and wherein a metal-oxide semiconductor field-effect transistor (MOSFET) is in electrical communication with the two metal plates.

15. The battery according to claim 14, wherein the metal plate is a copper plate.

16. The battery according to claim 14, wherein the thermal epoxy is not in contact with the electrical component configured to generate heat.

17. The battery according to claim 10, wherein the thermal epoxy is positioned between the battery housing and a first surface of the one or more thermal components without extending in a lateral direction beyond the first surface of the one or more thermal components.

18. The battery according to claim 10, wherein the thermal epoxy extends beyond a first surface of the one or more thermal components in a lateral direction along the surface of the battery housing.

19. The battery according to claim 10, wherein the thermal epoxy contacts the battery housing.

20. The battery according to claim 10, wherein the plurality of battery cells are lithium-ion battery cells.

21. A method of manufacturing a battery configured to have improved stability, the method comprising:
providing a battery management system (BMS) in electrical communication with a plurality of battery cells, the BMS having one or more thermal components configured to disperse heat from the BMS;
arranging a battery housing to enclose the battery cells and the BMS; and
applying a thermal epoxy between the BMS and the battery housing, wherein the thermal epoxy contacts the one or more thermal components and the battery housing.

22. A battery configured to have improved stability, the battery comprising:
a first battery cell having a top surface and a bottom surface;
a second battery cell having a top surface and a bottom surface; and
a battery cell spacer having a first surface contacting substantially all of the bottom surface of the first battery cell and a second surface contacting substantially all of the top surface of the second battery cell, wherein the first and the second surfaces of the battery cell spacer each include an adhesive component.

23. The battery according to claim 22, wherein the adhesive component covers substantially all of the first and second surfaces of the battery cell spacer.

24. The battery according to claim 22, further comprising:
a first layer of adhesive tape enclosing the first battery cell, the second battery cell, and the battery cell spacer, wherein the adhesive tape contacts substantially all of the top surface of the first battery cell.

25. The battery according to claim 24, further comprising:
a first protective plate having a top surface and a bottom surface, wherein the bottom surface contacts the first layer of adhesive tape and is positioned to substantially cover the top surface of the first battery cell.

26. The battery according to claim 25, further comprising:
a second layer of adhesive tape enclosing the first battery cell, the second battery cell, the battery cell spacer, the first layer of adhesive tape, and the first protective plate, wherein the second layer of adhesive tape contacts substantially all of the top surface of the first protective plate.

27. The battery according to claim 26, further comprising:
a plurality of additional protective plates enclosed by the second layer of adhesive tape, wherein the first protective plate and the plurality of additional protective plates are positioned to substantially cover each geometric side of the battery pack formed from the first battery cell, the second battery cell, and the battery cell spacer.

28. The battery according to claim 22, further comprising:
a third battery cell; and
a second battery cell spacer having a first surface contacting the second battery cell and a second surface contacting the third battery cell, wherein the first and the second surfaces each include an adhesive component.

29. The battery according to claim 22, wherein battery cells have a pouch form.

30. The battery according to claim 22, wherein the battery cell spacer has a smaller thickness than the thicknesses of the first and second battery cells.

31. The battery according to claim 22, wherein the first and second battery cells are lithium-ion cells.

32. A method of manufacturing a battery configured to have improved stability, the method comprising:
arranging a plurality of battery cell spacers between a plurality of battery cells to form a battery pack;
wrapping the battery pack in a first layer of adhesive tape, wherein the first layer of adhesive tape contacts substantially all of a top surface of the battery pack;
arranging a plurality of protective plates along the multiple geometric sides of the battery pack, wherein the protective plates are configured to substantially cover the multiple geometric sides; and
wrapping the battery pack, the first layer of adhesive tape, and the protective plates in a second layer of adhesive tape.

33. The method according to claim 32, wherein each battery cell spacer is configured to contact substantially all of each adjacent battery cell surface.

34. The method according to claim 32, further comprising:
shrink wrapping the battery pack, the first layer of adhesive tape, the protective plates, and the second layer of adhesive tape in a polymeric film.

35. The method according to claim 32, wherein the protective plates are positioned to substantially cover each geometric side of the battery pack.

36. The method according to claim 32, wherein battery cells have a pouch form.

37. The method according to claim 32, wherein the battery cell spacer has a smaller thickness than the thicknesses of the first and second battery cells.

38. The method according to claim 32, wherein the first and second battery cells are lithium-ion cells.

39. A battery configured to have improved stability, the battery comprising:
a plurality of battery cells;
a battery housing configured to enclose the battery cells, the battery housing having a main body and a cover; and
a stability cage at least partially enclosing the battery cells and positioned between the battery cells and the battery housing, the stability cage including:
a polymer frame having four sidewalls positioned in a rectangular form, wherein each sidewall includes a plurality of apertures forming a mesh pattern.

40. The battery according to claim 39, wherein the polymer frame includes a plurality of horizontal supports positioned along each corner of the polymer frame.

41. The battery according to claim 39, wherein the horizontal supports at least partially protrude outward from the surface of the sidewalls.

42. The battery according to claim 39, wherein the stability cage further includes an attachment mechanism configured to connect the stability cage to the battery housing.

43. The battery according to claim 39, wherein the plurality of apertures include hexagonal shaped apertures.
